(19) United States
(12) Patent Application Publication
(10) Pub. No.: US 2026/0056856 A1
(43) Pub. Date: Feb. 26, 2026

(54) SYSTEMS AND METHODS PROVIDING FAULT INJECTION

(71) Applicant: TEXAS INSTRUMENTS INCORPORATED, Dallas, TX (US)

(72) Inventors: Saya Goud Langadi, Sugar Land, TX (US); Naveen Kothuri, Rajahmundry (IN)

(21) Appl. No.: 19/005,058

(22) Filed: Dec. 30, 2024

Related U.S. Application Data
(60) Provisional application No. 63/686,274, filed on Aug. 23, 2024.

(51) Int. Cl. G06F 11/26; G06F 11/22

(52) U.S. Cl. CPC G06F 11/26; G06F 11/221

(57) ABSTRACT

A system includes fault emulation testing circuitry. The system may implement the fault emulation testing circuitry in a processing core, rather than in an interconnect. The fault emulation testing circuitry may inject a fault into an error correction hash.

### CROSS-REFERENCE TO RELATED APPLICATIONS

The present application claims the benefit of U.S. Provisional Patent Application 63/686,274, filed Aug. 23, 2024, the disclosure of which is hereby incorporated by reference in its entirety.

### TECHNICAL FIELD

The present disclosure relates generally to computer systems and, more specifically, to systems and methods for providing fault injection in computer systems.

### BACKGROUND

Safety protocols are used to ensure safety in electrical and/or electronic systems. For example, International Organization for Standardization (ISO) 26262 is an international standard for functional safety of electrical and/or electronic systems in automobiles. Such safety protocols analyze risk (e.g., the combination of the frequency of occurrence of harm and the severity of that harm) associated with electronic failures. Failures corresponding to electronics may be random or systematic. Random failures may correspond to hardware related permanent or transient failures due to a system component loss of functionality. Systematic failures may correspond to design faults, incorrect specifications, and/or not fit for purpose errors in software. Such safety protocols may analyze the electrical risks associated with a hardware processor that may process a signal to improve vehicle safety.

### SUMMARY

In an arrangement, a method includes: transmitting an information signal from a sending circuit to a receiving circuit; calculating a first error correction value of the information signal; injecting an error into the first error correction value, thereby generating a second error correction value; transmitting the second error correction value to the receiving circuit; receiving a result of an error correction check from the receiving circuit; and determining whether the error has been detected based on the result of the error correction check.

In an arrangement, a system includes: a sending circuit, including: first sequential logic configured to transmit an information signal; an error correction calculator configured to generate a first error correction value based on the information signal; a fault injection circuit configured to modify the first error correction value by injecting an error, thereby creating a second error correction value; and second sequential logic configured to transmit the second error correction value; and a receiving circuit, coupled to the sending circuit, configured to receive the information signal and the second error correction value, wherein the receiving circuit includes: error correction circuitry configured to process the information signal and the second error correction value and to return a result to the sending circuit.

In another arrangement, a circuit includes: a first sequential logic circuit configured to transmit an information signal to a receiving circuit; an error correction calculator circuit configured to generate a first error correction value based on the information signal; a fault injection circuit configured to modify the first error correction value by injecting an error, thereby creating a second error correction value; a second sequential logic circuit configured to transmit the second error correction value to the receiving circuit; and an error detector circuit configured to receive a response from the receiving circuit and to determine whether the error was detected based on the response.

### BRIEF DESCRIPTION OF THE DRAWINGS

Having thus described the invention in general terms, reference will now be made to the accompanying drawings, wherein:

FIG. 1 is an illustration of an example system, according to some embodiments.

FIG. 2 is an illustration of an example fault emulation module, according to some embodiments.

FIG. 3 is an illustration of example symbols, information signals, syndromes, and ECC data, according to some embodiments.

FIG. 4 is an illustration of an example syndrome table, according to some embodiments.

FIG. 5 is an illustration of an example method for fault emulation, according to some embodiments.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Automotive Safety Integrity Level (ASIL) falls under the umbrella of ISO 26262, and it specifies safety levels of automotive components. ASIL compliance requires systems to have high levels of latent fault metrics (LFM), and a given ASIL level may define specific fault detection and/or fault correction requirements. For example, the diagnostic mechanisms of a processor device may be required to have at least 90% fault detection coverage to meet a particular ASIL level. In some systems, the diagnostic mechanisms ensure that faults are detected and/or corrected by emulating (e.g., creating intentionally) commonly-encountered faults. A given fault or set of faults may be emulated for a given access through configuring registers to define when and where to inject the faults.

One of the hardware diagnostic and repair techniques that may be used in such systems is a SECDED (Single Error Correction, Double Error Detection) ECC (Error Correcting Code) check on bus access information going from an initiator to one or more interconnects. Fault emulation on each of the bus access information bits to verify the ECC check works may be required.

In an example of the present disclosure, whenever an access request is made by an initiator, the access information buses including address and size of access are broadcast by the initiator to the rest of a System-on-Chip (SoC), which may include an intended destination (e.g., a memory and/or a peripheral) and one or more other unintended destinations. Along with this, the ECC data computed for the information flowing from initiator to the intended destination (e.g., the contents of the access request) is also sent as a sideband signal (e.g., via a different set of conductive traces, via a different data path and/or via a different modality). Once the access request reaches an interconnect associated with the destination, the access information is checked against the previously computed ECC data in the ECC checker block. Some example ECC checkers can detect and correct single bit faults and detect double bit faults.

Faults may be emulated to test the ECC checker block by configuring associated Memory Mapped Registers (MMRs) to define where to inject the faults. User software sets the address of the read or write or fetch access, which, when the processor core provides the access request, causes the fault to be injected as specified by altering the corresponding bit fields. Fault emulation logic, including configuration registers, may reside in each of the interconnects serving the corresponding memory or peripherals. This is because, if instead a fault is injected at the initiator level itself, the access routing address mux gates may receive fault-corrupted values of the address, and the access may not even reach the intended destination interconnect in order to test the associated ECC checker block. As a result, it may become difficult to inject faults and check their coverage if fault emulation is done at initiator level.

Various embodiments implement fault emulation logic in an initiator (e.g., a processor core) instead of or in addition to implementing in the interconnects (e.g., peripheral bridges, memory controllers) of the system. Furthermore, rather than inject faults into the information signal itself (e.g., the data indicating the address of the read or write or fetch access), various embodiments may instead manipulate ECC data. As a result, the information signal having the access request may avoid being routed to an unintended destination. Also, various embodiments may save semiconductor area by avoiding duplication when compared to systems that would otherwise implement multiple and identical fault emulation logic at the interconnects. In other words, various embodiments may implement fault emulation logic at the processor core and omit fault emulation logic at multiple interconnects, which would generally be expected to reduce a number of instances of the fault emulation logic.

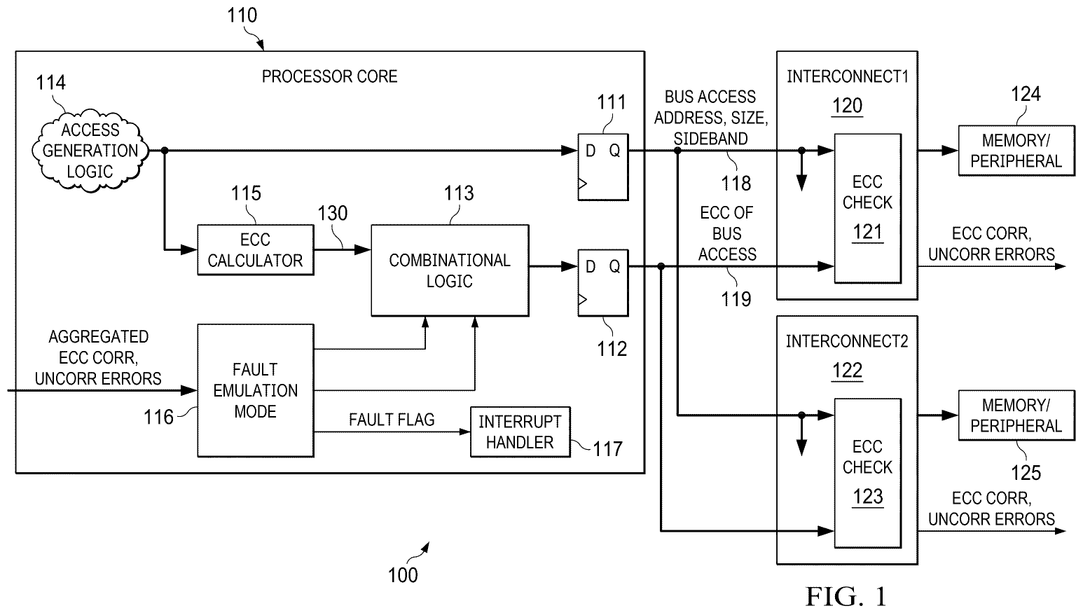

FIG. 1 is an illustration of example system 100, according to some embodiments. Example system 100 may be implemented on one or more semiconductor dies. For instance, each of the components 110-125 may be included on a same semiconductor die, even with additional components (not shown), as an SoC. In another example, the processor core 110 may be implemented on a semiconductor die, and the interconnects 120, 122 and their respective memory or peripheral devices 124, 125 may be implemented on one or more other semiconductor dies. In yet another example, the processor core 110 and the interconnects 120, 122 may be implemented on a first semiconductor die, and the memory or peripheral devices 124, 125 may be implemented on one or more semiconductor dies separate from the first semiconductor die. One or more given semiconductor dies may be included within a semiconductor package, and that package may be mounted to a printed circuit board or other component.

Furthermore, while FIG. 1 shows only a single processor core 110, the scope of implementations may include a system having two or more processor cores. Also, the quantity of interconnects and peripheral devices may be scaled as appropriate to accommodate any appropriate number and type of memory devices and/or peripheral devices.

Processor core 110 may include any appropriate processor core according to any appropriate processor architecture. For instance, processor core 110 may be a general-purpose processor core, a special-purpose processor, a reduced instruction set computer, a graphics processing unit, or other processor core.

Processor core 110 includes access generation logic 114, which may generate bits associated with a read or write access request directed to memory or peripheral devices 124, 125. For instance, the access generation logic 114 may generate bits that indicate a bus access address, an access size, and any appropriate sideband signals to cause a read or write access to occur. During an example read access, the processor core 110 may request data from either one of the memory or peripheral devices 124, 125. During an example write access, the processor core 110 may request to write data to either one of the memory or peripheral devices 124, 125.

Access generation logic 114 generates the data bits that make up an access request (e.g., bits that specify a type of access, an address, other metadata, and/or a data payload), which may be referred to as an information signal in some examples. The information signal, which is received by sequential logic circuit 111 from access generation logic 114, may be distinct from error correction data 130 used to verify the integrity of the data bits. In this example, the error correcting code (ECC) calculator 115 receives the information signal from the access generation logic 114 and generates ECC data 130 therefrom. The ECC calculator 115 may use any appropriate error correction algorithm to generate the ECC data 130. In some examples, the ECC calculator 115 may generate a hash based on a hash function. Thus, in some examples, the ECC data 130 may be calculated from the information signal, and it may be used to correct an error in the information signal.

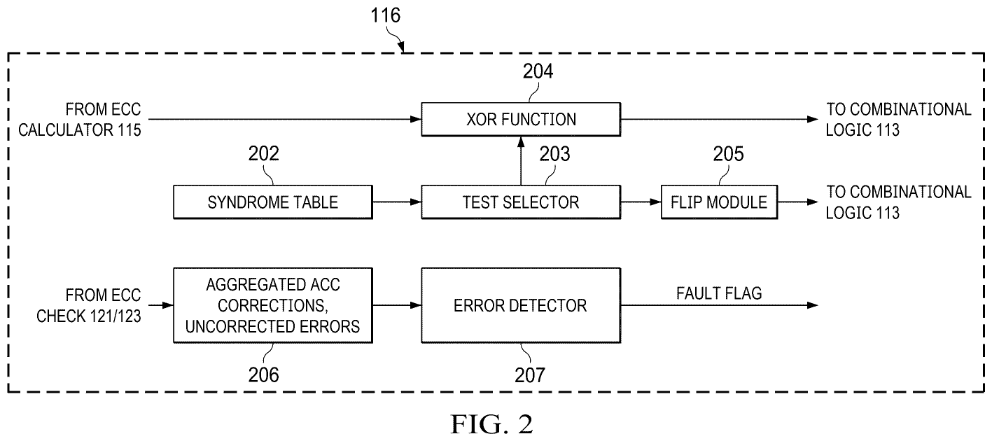

Processor core 110 also includes fault emulation module 116, which is explained in more detail with respect to FIG. 2. Fault emulation module 116 may inject faults onto bus 119 in two different ways. In one way, fault emulation module 116 may send an entire hash to sequential logic circuit 112. In another way, fault emulation module 116 may manipulate one bit at a time of the ECC data 130, and combinational logic 113 then loads the ECC data with the error into the sequential logic circuit 112. Thus, fault emulation module 116 may inject one or more false bits (an error) into the ECC data 130.

Fault emulation module 116 may inject an error into the ECC data 130 during a fault emulation operation of the system 100. For instance, fault emulation operations may be performed at power up of system 100, during manufacture of system 100, periodically from time to time, or otherwise as appropriate. However, during normal operation of system 100, the combinational logic 113 may be set so that the ECC data 130 is not modified to include an error, and the ECC data may be placed on the bus 119 unaltered.

Memory or peripheral devices 124, 125 may each be implemented as a memory device or as a peripheral device. Examples of peripheral devices include hard drives, solid-state drives, analog-to-digital converters, communications interfaces such as network interfaces, and the like. Examples of memory devices may include various types of random-access memory (RAM), such as a static random-access memory (SRAM) device, a dynamic random-access memory (DRAM) device, or other volatile or nonvolatile RAM device.

Interconnect 120 may be implemented as a peripheral bridge or memory controller, as appropriate. For instance, if device 124 is implemented as a memory device, then interconnect 120 may be implemented as a memory controller. If device 124 is implemented as a peripheral device, then interconnect 120 may be implemented as a peripheral bridge. The same is true of interconnect 122 and device 125.

In one aspect, the processor core 110 acts as an initiator for access requests, and the interconnects 120, 122 act as targets for those access requests. Looking at interconnect 120, if it is implemented as a memory controller, then it may be configured to receive a read or write request from the processor core 110, perform an input or output operation on the memory device 124 to either read out data or store data, and then return a result of the read or write request to the processor core 110. The same is true of interconnect 122 and device 125. If interconnect 120 is implemented as a peripheral bridge, then it may be configured to receive an access request, such as a read or write request, interact with the hardware of the device 125 consistent with the access request, and then return a result of the access request to the processor core 110. The same is true of interconnect 122 and device 125.

Interconnect 120 includes ECC check circuit 121. Similarly, interconnect 122 includes ECC check circuit 123. For a given access request, the sequential logic 111 transmits the information signal onto bus 118, where the information signal is broadcast to the interconnects 120, 122. During the access request, the sequential logic circuit 112 transmits the ECC data onto bus 119, where the ECC data is broadcast to the interconnects 120, 122. A given interconnect 120 or 122 may then parse the bus access address and determine whether the bus access address is directed to that specific interconnect 120 or 122. If an interconnect 120 or 122 determines that is not a target of the access request, then the interconnect 120 or 122 may ignore the access request. If an interconnect 120 or 122 determines that it is a target of the access request, then it may proceed with performing further actions with respect to the access request.

In one example, an access request may be broadcast on bus 118, and it may be addressed so that interconnect 120 is its target. Interconnect 122 may then ignore the access request. ECC check circuit 121 is configured to perform an ECC check on the information signal using the ECC data on bus 119. This may include generating a second set of ECC data and comparing the second set of ECC data to the first set of ECC data received via the ECC bus 119 and generated by ECC calculator 115 with or without a fault injected by combinational logic 113.

In one example, ECC check circuit 121 may be configured to perform SECDED. For instance, if a single bit of the data on bus 118 has an error (sometimes referred to as a bit flip), then the ECC check circuit 121 may identify the particular bit with the error and may output a correction for that single bit. For instance, the ECC check circuit 121 may output the full word in its correct form or may simply indicate which bit had the error. In an example in which two bits have errors, the ECC check circuit 121 may output an indication of an uncorrected error. The indication of the uncorrected error may be understood by the processor core 110 as an indication that two bits have errors, though the identities of the two bits may be indeterminable. More than two bits having errors may be handled in any appropriate manner, though SECDED output in such scenario may be undefined. ECC check circuit 123 may perform similarly.

During normal operation, fault emulation module 116 may be idle, and combinational logic 113 may be configured to output the ECC data 130 as-is. During fault emulation operations, fault emulation module 116 is configured to receive and aggregate the output from the ECC check circuits 121, 123. Specifically, the fault emulation module 116 may be configured to receive and aggregate ECC corrections and uncorrected errors in order to perform fault analysis on system 100. Fault analysis is discussed in more detail with respect to FIGS. 2-5. Fault analysis in some examples may include checking functionality of the ECC check circuits 121, 123.

The results of the fault analysis may be handled in any appropriate manner, though in some implementations, a detection of a malfunction in ECC check circuit 121 or 123 may result in fault emulation module 116 raising a fault flag to interrupt handler 117. Although not described in detail herein, system 100 may be implemented to have self-repair abilities, so that malfunctions discovered during fault emulation may be repaired in whole or in part.

FIG. 2 is an illustration of example fault emulation module 116 of FIG. 1, according to some embodiments. Example fault emulation module 116 may be implemented using software, firmware, and/or hardware logic as appropriate. For instance, in one example, fault emulation module 116 may be implemented using hardware logic in processor core 110, though the hardware logic may be responsive to signals transmitted from software to, e.g., control selection of tests. In another example, fault emulation module 116 may be implemented using firmware logic or may be implemented in a basic input output system (BIOS). Furthermore, fault emulation module 116 may be enabled using any appropriate technique, such as signals from software, to define whether the processor core 110 operates in fault emulation mode or normal access mode.

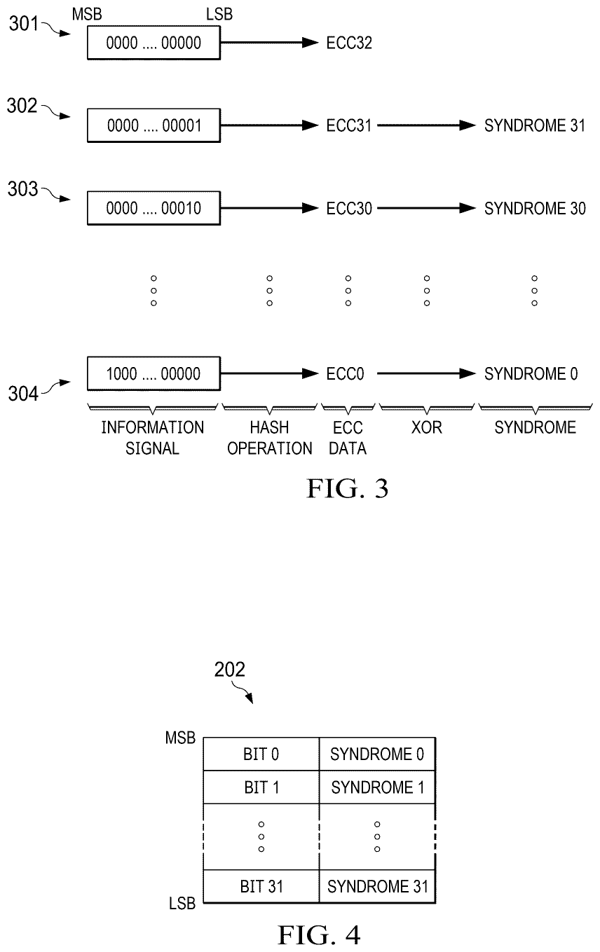

Fault emulation module 116 includes test selector 203. Test selector 203 may be configured to select which bit error to test with respect to the information signal. For instance, given a first known good information signal and a first set of ECC data associated with the first information signal, the test selector 203 may select a syndrome from the syndrome table 202, where that particular syndrome corresponds to a particular bit error. Syndromes are explained in more detail with respect to FIG. 3, but in sum, the syndrome may be used to generate a second set of ECC data that corresponds to a second information signal with one or more bits that are different from the first information signal. In contrast to the first information signal, the second information signal need not be correct, and may not even be recognized or processed by any of the destinations. By transmitting the first known good information signal and the second set of ECC data, both the information signal and the ECC data will be received and processed (e.g., checked by ECC check circuitry) by one of the interconnects. If functioning properly, the ECC check circuitry of the interconnect will detect the specified bit error in the first information signal despite the first information signal being correct.

To generate the second set of ECC data, the test selector 203 may apply that selected syndrome to first set of ECC data via the XOR function 204. The XOR function 204 may also receive the first set of ECC data from the ECC calculator 115. The XOR function 204 may perform an XOR function on the selected syndrome and the first set of ECC data. The output of the XOR function 204 is a series of bits, where that series of bits may correspond to the second set of ECC data associated with the particular bit error. The output of the XOR function 204 may be transmitted to sequential logic circuit 112, via sequential logic 113, and then placed in bus 119.

During a fault emulation operation, one or more of the ECC check circuits 121, 123 may then receive the first information signal on bus 118 and the second set of ECC data (e.g., the result of the XOR function 204) on bus 119. With that input, the ECC check circuits 121, 123 may perform ECC correction. In this example, the fault emulation injected a fault into the second set of ECC data so that the modified ECC data does not match the first information signal on bus 118.

In an example in which the first information signal is all zeros, and the modified ECC data is associated with a single one value at the mth bit, the ECC check circuits 121, 123 each would detect that the information signal is incorrect at the mth bit and return that detected error to the fault emulation module 116 at the aggregated ECC corrections and uncorrected errors block 206. For instance, the ECC check circuits 121, 123 may each return a data word that is all zeros with a single one at the mth bit, and that data word may be received by the aggregated ECC corrections and uncorrected errors block 206. A malfunction in operation of either one of the ECC check circuits 121, 123 may be expected to return something other than an indication of a bit error at the mth bit.

The test selector may perform further tests, each of the tests corresponding to a respective bit error, and the output of the ECC check circuits 121, 123 may be returned to the aggregated ECC corrections and uncorrected errors module 206. After some time, the error detector module 207 may parse the data stored at the aggregated ECC corrections and uncorrected errors module 206 to determine whether the ECC check circuits 121, 123 performed correctly.

The syndromes, stored at syndrome table 202, are explained with respect to FIG. 3.

An information signal may include any appropriate quantity of bits in a word, and ECC data may also include any appropriate quantity of bits. For purposes of this illustration, the quantity of bits in an information signal is 32, and the quantity of bits in ECC data is seven, and it is understood that these example quantities may be scaled as appropriate in other embodiments.

Information signal 301 is a 32-bit binary number of all zeros. Information signal 302 is a 32-bit binary number in which the least significant bit has been changed to a one, and the other bits are zeros. Information signal 303 is a 32-bit binary number in which the digit next to the least significant bit has been changed to a one, and the other bits are zeros. Information signals 302-304 illustrate a sequence in which all of the bits in an information signal are zero, except for a single bit which is a one, and that bit is shifted over one place with respect to the previous information signal. The ellipses indicate that the illustration is truncated for convenience. Information signal 304 is the final information signal of the set, where the most significant bit is a one, and the other bits are zero. Thus, the set of information signals illustrated by information signals 301-304 includes a single information signal with all zeros, and 32 unique information signals in which a single one of the bits has been changed to a one and the remaining bits are zero.

The hash operation includes any appropriate hash operation that may be performed by ECC calculator 115 to generate ECC data from a respective information signal. For purposes of this example, the ECC data generated from information signal 301 is referred to as ECC 32. Applying the hash operation to the information signal 302 yields as a result the ECC data ECC 31; applying the hash operation to the information signal 303 yields as a result the ECC data ECC 30; applying the hash operation to the information signal 304 yields as a result the ECC data ECC 0. Each one of the 32+1 information signals corresponds to a respective and unique ECC data hash ECC 32-ECC 0.

In this example, there are 32 syndromes, each syndrome corresponding to one of the information signals 302-304. In one aspect, each one of the information signals 302-304 represents a bit flip error that may occur between sequential logic 111 and ECC check circuit 121 or 123. Thus, each one of the syndromes corresponds to a bit flip error.

Various embodiments may calculate the syndromes 31-0 according to any appropriate technique. In this example, syndrome 31 may be calculated by performing an XOR operation on ECC 32 and ECC 31, syndrome 30 may be calculated by performing an XOR operation on ECC 32 and ECC 30, and on and on so that syndrome 0 may be calculated by performing an XOR operation on ECC 32 and ECC 0. Thus, the syndromes themselves may be considered hashes, and each syndrome corresponds to a respective bit flip error.

The syndromes may be arranged in a table, such as at syndrome table 202, as illustrated in FIG. 4. An example syndrome table 202, each syndrome may be associated with a respective bit position of a bit flip error. For instance, a bit flip error of the most significant bit position (Bit 0) may be associated with syndrome 0, a bit flip error of the next most significant bit position (Bit 1) may be associated with syndrome 1, and on and on through the least significant bit position (Bit 31) being associated with syndrome 31. In this manner, the syndromes may be accessed in syndrome table 202 by using a bit position as a key.

Now returning to FIG. 2, an example of fault emulation for a particular bit flip error is illustrated with respect to the concepts discussed in FIGS. 3-4. The test selector module 203 may work through an algorithm in which it tests each of the bit positions and starts at the least significant bit position, as illustrated by information signal 302, Bit 31, and syndrome 31. Accordingly, the test selector module may select syndrome 31 from the syndrome table 202 and provide the syndrome 31 to the XOR function module 204. In this example, the access generation logic 114 may output information signal 301 for each of the tests, so that ECC emulator 115 may output ECC data hash ECC 32. XOR function module 204 applies an XOR operation on ECC 32 and syndrome 31. The XOR operation of ECC 32 and syndrome 31 generates and ECC data hash equal to ECC 31. The XOR function module 204 outputs the resulting data hash (ECC 31) to the combinational logic 113, then to sequential logic circuit 112, which transmits the data hash onto bus 119.

At this point, the ECC check circuit 121 receives information signal 301 (all zeros) on bus 118 and receives ECC 31 on bus 119. From the standpoint of the ECC check circuit 121, there would be no error to detect if it received information signal 301 and an ECC data hash corresponding to information signal 301 (i.e., ECC 32). However, the ECC check circuit 121 instead receives the ECC data hash ECC 31, which corresponds to information signal 302. Thus, the ECC check circuit 121, assuming it is working correctly, may detect that the least significant bit has been received incorrectly as a zero on bus 118. This is because ECC 31 and ECC 32 differ by more than two bits, and the SECDED hardware of ECC check circuit 121 is configured to determine that in such a scenario ECC 31 is correct and that the bus 118 has a single bit flip.

The ECC check circuit 121 may employ any appropriate technique. For instance, in an example, the ECC check circuit 121 may calculate an ECC data hash based on the received information signal 301, which would be expected to generate ECC 32, and then the ECC check circuit 121 may determine whether ECC 32 matches ECC 31. Assuming that the ECC check circuit 121 operates successfully, then the ECC check circuit 121 may determine that there is no match. In an example, the ECC check circuit 121 may then use the ECC data hash ECC 31 to repair the received information signal 301 by changing the least significant bit from a zero to a one. In other words, changing the least significant bit from a zero to a one would produce information signal 302. Continuing with the example, the ECC check circuit 121 may then return the result of its operation back to the fault emulation module 116. For instance, the ECC check circuit 121 may return the result in any appropriate manner, such as by returning the repaired information signal (information signal 302), may return an identifier of the place of the repaired bit, and/or the like.

The result from the ECC check circuit 121 may then be stored at the aggregated ECC corrections and uncorrected errors module 206. As noted above, assuming that the ECC check circuit 121 operates correctly, then the returned result should indicate a corrected error of the least significant bit. If the ECC check circuit 121 does not operate correctly, then the returned result would be expected to be something different, and in some implementations may be any result other than indicating a corrected error of the least significant bit.

Of note in this example, a given ECC data hash (ECC YZ) may be XORed with ECC 32 to generate a respective syndrome (syndrome YZ). Further in this example, a given syndrome may be XORed with ECC 32 to generate a corresponding ECC data hash (e.g., XOR (ECC 32, syndrome YZ) to generate ECC YZ.

The test selector 203 may then access the syndrome table 202 again to receive syndrome 30, which corresponds to a bit flip error of the next to least significant bit (as in information signal 303). The test selector 203 may then provide syndrome 30 to the XOR function module 204, and XOR function 204 also receives ECC 32 from the ECC calculator 115. The XOR function module 204 may then perform an XOR operation on ECC 32 and syndrome 30 to generate the ECC hash data ECC 31, which it provides to sequential logic circuit 112. The ECC check circuit 121 also receives information signal 301 on bus 118. The ECC check circuit 121 then performs a similar check as described above. Assuming that the ECC check circuit 121 performs correctly, then it should return a result indicating that the next to least significant bit has been corrected. Otherwise, the ECC check circuit 121 may return a different result, where a different result would indicate a failure by the ECC check circuit 121. The result may then be stored in the aggregated ECC corrections and uncorrected errors module 206.

The test selector 203 may then keep going, one by one, through the table 202 so that each of the different bit errors Bit 0-Bit 31 are injected by the fault emulation module 116, and results aggregated at module 206.

The error detector module 207 then parses the contents of the module 206 to determine whether the contents indicate any malfunction with respect to ECC check circuit 121. For instance, if the results in module 206 all indicate their respective bit errors, then there may be no malfunction. On the other hand, should one or more of the results in module 206 indicate that ECC check circuit 121 did not catch a bit error, then the error detector module 207 may raise a fault flag to the interrupt handler 117.

While the example above refers to testing for malfunctions with respect to ECC check circuit 121, the fault emulation module 116 may perform same or similar tests to check the functionality of any other ECC check circuits, such as ECC check circuit 123.

The example described immediately above tests the functionality of an ECC check circuit with respect to the information signals on bus 118 by using a known good information signal with a set of ECC data manipulated to represent that the information signal has one or more incorrect bits. However, it is possible that there may be a malfunction of the ECC check circuit with respect to the ECC data on bus 119. Accordingly, various embodiments may provide techniques to check whether the ECC check circuit functions properly with respect to the ECC data on bus 119 by using a known good information signal with a set of ECC data manipulated to represent that the ECC data has one or more incorrect bits. For instance, test selector 203 may cause flip module 205 to control combinational logic 113 to flip one bit at a time of the ECC data 130.

In one example, the test selector 203 may be configured to control XOR function module 204 so that XOR function module 204 passes the ECC data from the ECC calculator to the flip module 205 without performing an XOR operation. The test selector 203 may then be configured to control flip module 205 to flip a single bit of the ECC data (e.g., the least significant bit). For instance, the flip module 205 may cause the combinational logic 113 to flip a single, selected bit at a time of the ECC data 130. In this way, the test selector 203 may inject a single-bit error into the ECC data hash. In an example, the ECC check circuits 121, 123 may be configured to detect a single-bit error in the ECC data hash, correct that single bit error, and report the corrected bit back to the fault emulation module 116. In other words, the ECC check circuits 121, 123 may be configured to perform SECDED on both the information signal on bus 118 as well as the ECC data hashes on bus 119.

The test selector 203 may be configured to inject an error in each of the subsequent bits of the ECC data hash, one at a time, receive the results from the ECC check circuits 121, 123, perform error detection at the error detection module 207, and raise a fault flag to the interrupt handler 117 if appropriate.

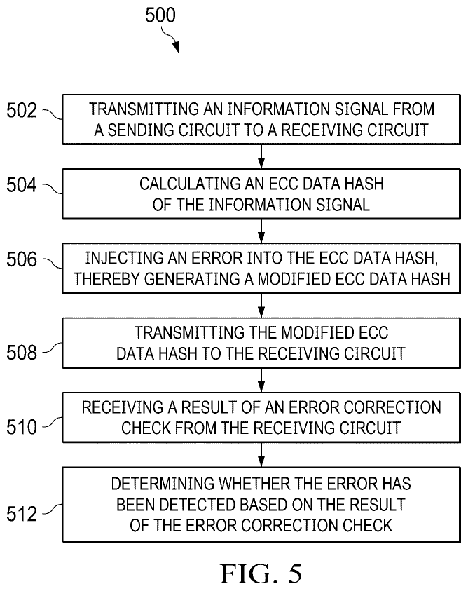

FIG. 5 is an illustration of an example method 500, for fault emulation, according to some embodiments. Method 500 may be performed by a fault emulation module, such as fault emulation module 116 of FIG. 1. For instance, a fault emulation module may include hardware logic, firmware logic, and/or software logic that may provide fault emulation in a system, such as system 100 of FIG. 1. In some embodiments, some or all of the functions of fault emulation module 116 may be performed under control of a separate test control module, such as may be implemented using software or firmware and may be executed on a same processor core or a different processor core than the processor core hosting the fault emulation module. For instance, a separate test control module may control test selector 203 of FIG. 2 to select a suite of tests, to select testing with respect to bit flip errors of the information signal or to select testing with respect to bit flip errors of the ECC data hashes), to put the fault emulation module 116 into idle mode (e.g., normal access operation of the processor core 110) or into active mode (e.g., fault emulation mode).

At action 502, an information signal is transmitted from a sending circuit to a receiving circuit. An example of a sending circuit may include processor core 110, which transmits an information signal on bus 118 via sequential logic 111. An example of a receiving circuit may include an interconnect, such as a memory controller, a peripheral bridge, or another component which provides access to some downstream resource.

At action 504, the processor core may calculate an ECC data hash of the information signal. This may be done prior to or concurrent with the transmission of the information signal. In the example of FIG. 1, the ECC calculator 115 may calculate an ECC data hash of the information signal using any appropriate technique. In some embodiments, the ECC data hash may allow sufficient bits for at least one bit of data in the information signal to be repaired. Examples of ECC data hashes are illustrated above at FIG. 3, where ECC data hashes are illustrated as ECC 0-ECC 32. In the examples discussed above, the information signal may include an appropriate signal, such as an all-zeros signal (e.g., information signal 301), and its associated ECC data hash is illustrated as ECC 32.

At action 506, the fault emulation module may inject an error into the error correction data hash. In this example, action 506 generates a modified ECC data hash that indicates that at least one bit of the information signal is incorrect. For instance, action 506 may include performing a Boolean operation (e.g., an XOR operation) using the error correction data hash and a second hash (e.g., a syndrome). The error may be injected by changing one or more bits of the calculated ECC data hash to conform to the result of the Boolean operation. In one example, the result of the Boolean operation may include a modified ECC data hash that corresponds to a particular bit flip.

Action 508 includes transmitting the modified ECC data hash to the receiving circuit. In the examples above, the fault emulation module 116 is configured to transmit the modified ECC data hash to an interconnect, such as interconnect 120 or 122. As a result of actions 502 and 506, an ECC check circuit (e.g., circuit 121 or 123) may receive both the information signal and a modified ECC hash. For instance, the information signal may be an all-zeros information signal, and the modified ECC hash may correspond to a similar signal with one bit having been flipped.

Therefore, the ECC check circuit may perform an ECC check on the information signal using the ECC data hash. Assuming that the ECC check circuit works correctly, it should identify a single bit flip error in the information signal.

At action 510, the fault emulation module receives a result of the error correction check from the receiving circuit. The error correction check may indicate that a single bit was flipped in the information signal, which may be indicative of no malfunction of the receiving circuit. On the other hand, the error correction check may indicate that something other than a single bit was flipped in the information signal, which may be indicative of a malfunction of the receiving circuit.

At action 512, the fault emulation module may determine whether the error has been detected based on the result of the error correction check. For instance, the fault emulation module may include an error detector module that is configured to parse the results from the receiving circuit and determine whether the receiving circuit has malfunctioned.

Method 500 may be performed as part of a larger fault emulation operation. For instance, method 500 may further include selecting syndromes one at a time to emulate one bit flip of the information signal at a time. The fault emulation module, or an entity that controls the fault emulation module, may cause the fault emulation module to select syndromes according to an order of the bits so that each possible bit flip is tested from least significant bit to most significant bit (or vice versa). Thus, the results from the receiving circuit may be batched, and action 512 may be performed on a batch of results.

Method 500 may be performed at any appropriate time, such as during manufacturing and testing of system 100, during power on or reset of system 100, or at other times.

The term “semiconductor die” is used herein. A semiconductor device can be a discrete semiconductor device such as a bipolar transistor, a few discrete devices such as a pair of power FET switches fabricated together on a single semiconductor die, or a semiconductor die can be an integrated circuit with multiple semiconductor devices such as the multiple capacitors in an A/D converter. The semiconductor device can include passive devices such as resistors, inductors, filters, sensors, or active devices such as transistors. The semiconductor device can be an integrated circuit with hundreds or thousands of transistors coupled to form a functional circuit, for example a microprocessor or memory device. The semiconductor device may also be referred to herein as a semiconductor device or an integrated circuit (IC) die.

The term “semiconductor package” is used herein. A semiconductor package has at least one semiconductor die electrically coupled to terminals and has a package body that protects and covers the semiconductor die. In some arrangements, multiple semiconductor dies can be packaged together. For example, a power metal oxide semiconductor (MOS) field effect transistor (FET) semiconductor device and a second semiconductor device (such as a gate driver die, or a controller die) can be packaged together to from a single packaged electronic device. Additional components such as passive components, such as capacitors, resistors, and inductors or coils, can be included in the packaged electronic device. The semiconductor die is mounted with a package substrate that provides conductive leads. A portion of the conductive leads form the terminals for the packaged device. In wire bonded integrated circuit packages, bond wires couple conductive leads of a package substrate to bond pads on the semiconductor die. The semiconductor die can be mounted to the package substrate with a device side surface facing away from the substrate and a backside surface facing and mounted to a die pad of the package substrate. The semiconductor package can have a package body formed by a thermoset epoxy resin mold compound in a molding process, or by the use of epoxy, plastics, or resins that are liquid at room temperature and are subsequently cured. The package body may provide a hermetic package for the packaged device. The package body may be formed in a mold using an encapsulation process, however, a portion of the leads of the package substrate are not covered during encapsulation, these exposed lead portions form the terminals for the semiconductor package. The semiconductor package may also be referred to as a “integrated circuit package,” a “microelectronic device package,” or a “semiconductor device package.”

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A method comprising:
transmitting an information signal from a sending circuit to a receiving circuit;
calculating a first error correction value of the information signal;
injecting an error into the first error correction value, thereby generating a second error correction value;
transmitting the second error correction value to the receiving circuit;
receiving a result of an error correction check from the receiving circuit; and
determining whether the error has been detected based on the result of the error correction check.

2. The method of claim 1, wherein injecting the error into the first error correction value comprises:
retrieving a value associated with the error;
performing a Boolean operation on the value associated with the error and the first error correction value to generate the second error correction value; and
placing the second error correction value on a bus.

3. The method of claim 2, wherein the Boolean operation comprises an XOR operation.

4. The method of claim 1, further comprising:
selecting a value from a plurality of syndrome values, wherein each syndrome value of the plurality of syndrome values is based upon the first error correction value and a respective bit error;
performing a Boolean operation on the value and the first error correction value to generate the second error correction value; and
placing the second error correction value on a bus.

5. The method of claim 4, wherein selecting the value is performed based on the respective bit error associated with the value.

6. The method of claim 4, wherein the value comprises a result of an XOR operation on the first error correction value and the respective bit error value.

7. The method of claim 1, wherein injecting the error into the first error correction value comprises:
flipping a single bit of the first error correction value; and
wherein determining whether the error has been detected includes determining whether the error exists with respect to the receiving circuit detecting single-bit errors in the first error correction value.

8. The method of claim 1, wherein transmitting the second error correction value to the receiving circuit comprises transmitting the second error correction value from a processor core to a memory controller or a peripheral bridge.

9. The method of claim 1, wherein determining whether the error has been detected includes determining whether the error exists with respect to the receiving circuit detecting single-bit errors in the information signal.

10. A system comprising:
a sending circuit, including:
first sequential logic configured to transmit an information signal;
an error correction calculator configured to generate a first error correction value based on the information signal;
a fault injection circuit configured to modify the first error correction value by injecting an error, thereby creating a second error correction value; and
second sequential logic configured to transmit the second error correction value; and
a receiving circuit, coupled to the sending circuit, configured to receive the information signal and the second error correction value, wherein the receiving circuit includes:
error correction circuitry configured to process the information signal and the second error correction value and to return a result to the sending circuit.

11. The system of claim 10, wherein the sending circuit comprises a processor core.

12. The system of claim 11, wherein the receiving circuit comprises a peripheral bridge or a memory controller.

13. The system of claim 10, wherein the error correction circuitry is configured to return the result as an indication of either a corrected error or an uncorrected error to the sending circuit, further wherein the sending circuit is configured to determine whether the error has been detected by processing the result.

14. The system of claim 10, wherein the fault injection circuit is configured to:
select a syndrome value from a plurality of syndrome values, wherein each syndrome value of the plurality of syndrome values is based upon the first error correction value and a respective bit error value; and
perform a Boolean operation on the syndrome value and the first error correction value to generate the second error correction value.

15. The system of claim 14, wherein the fault injection circuit comprises an XOR gate configured to perform the Boolean operation.

16. The system of claim 10, wherein the fault injection circuit is configured to modify the first error correction value by flipping a single bit of the first error correction value.

17. A circuit comprising:
a first sequential logic circuit configured to transmit an information signal to a receiving circuit;
an error correction calculator circuit configured to generate a first error correction value based on the information signal;
a fault injection circuit configured to modify the first error correction value by injecting an error, thereby creating a second error correction value;
a second sequential logic circuit configured to transmit the second error correction value to the receiving circuit; and
an error detector circuit configured to receive a response from the receiving circuit and to determine whether the error was detected based on the response.

18. The circuit of claim 17, wherein the fault injection circuit and the error detector circuit are implemented in a processor core.

19. The circuit of claim 17, wherein the fault injection circuit is configured to:
select a first syndrome value from a plurality of syndrome values; and
perform an XOR operation on the first syndrome value and the first error correction value, wherein an output of the XOR operation is the second error correction value.

20. The circuit of claim 17, wherein the information signal is a set of all zeros, and wherein the second error correction value corresponds to a particular bit of the information signal being flipped.
